(19) United States
(12) Patent Application Publication
(10) Pub. No.: US 2021/0016215 A1
(43) Pub. Date: Jan. 21, 2021

(54) VENTILATION DEVICE FOR FILTERING AIR AND FOR SEPARATING WATER AEROSOLS FROM AIR

(71) Applicant: Filtration Group GmbH, Oehringen (DE)

(72) Inventors: Steffen Gorzawski, Bad Rappenau (DE); Wolfgang Kugel, Wolpertshausen (DE); Andreas Szontkowski, Obersulm (DE); Fritz Roediger, Untereisesheim (DE)

(73) Assignee: Filtration Group GmbH, Oehringen (DE)

(21) Appl. No.: 17/041,437

(22) PCT Filed: Mar. 14, 2019
(86) PCT No.: PCT/EP2019/056459

§ 371 Date: Sep. 25, 2020

(30) Foreign Application Priority Data
Mar. 27, 2018 (DE) 10 2018 204 635.2

(51) Int. Cl. B01D 46/00; B01D 46/10; B01D 46/44; F24F 3/16; F03D 80/60

(52) U.S. Cl. CPC B01D 46/0031; B01D 46/0005; B01D 46/002; B01D 46/0045; B01D 46/10; F05B 2260/20; B01D 46/446; F24F 3/1603; F03D 80/60; B01D 2273/30; F05B 2220/30; B01D 46/444

(57) ABSTRACT

A ventilation device for filtering air and for separating water aerosols from air may include at least one filter element, at least one housing, at least one fan, and at least one flow adapter. The filter element may be secured in the housing such that air is flowable through an inlet opening of the housing to an outlet opening of the housing in a flow direction. The fan may be secured on the outlet opening downstream of the housing in the flow direction. The flow adapter may be secured on the inlet opening upstream of the housing in the flow direction. A coupling frame may be secured in an airtight manner between the housing and the flow adapter. The coupling frame may include a discharge channel arrangement for draining water collected in the at least one filter element.

### CROSS-REFERENCE TO RELATED APPLICATIONS

This application claims priority to International Patent Application No. PCT/EP2019/056459, filed on Mar. 14, 2019, and German Patent Application No. DE 10 2018 204 635.2, filed on Mar. 27, 2018, the contents of both of which are hereby incorporated by reference in their entirety.

### TECHNICAL FIELD

The invention relates to a ventilation device for filtering air and for separating water aerosols from air.

### BACKGROUND

Ventilation devices for filtering air and for separating water aerosols from air are already known from the prior art and are used for example in wind power plants. Depending on the site of the wind power plant, the air aspirated from outside must be purified and dehumidified, in order to protect electronic or electric components inside the wind power plant. To this end, fans suck the air into the wind power plant through filter elements, in which the aspirated air is purified and dehumidified. The water separated in the filter element is then discharged from the ventilation device. To this end, the respective housing in each case has a water pipe for draining the collected water to the outside. Both the mounting and the maintenance of the water pipes are connected with a high outlay of time and effort.

### SUMMARY

It is therefore the object of the invention to specify an improved or at least alternative embodiment, for a ventilation device of the generic type, in which the described disadvantages are overcome.

This object is achieved according to the invention by the subject matter of the independent claim(s). Advantageous embodiments are the subject matter of the dependent claim(s).

The present invention is based on the generic idea, in a ventilation device for filtering air and for separating water aerosols from air, of draining the separated water by means of a common arrangement. In this case, the generic ventilation device has at least one filter element, at least one housing, at least one fan and at least one flow adapter. The at least one filter element is in this case secured in the at least one housing such that air can flow through from an inlet opening to an outlet opening of the at least one housing in a flow direction. The at least one fan is fixed on the outlet opening downstream of the at least one housing in the flow direction and the at least one flow adapter is secured on the inlet opening upstream of the at least one housing in the flow direction. Furthermore, a coupling frame is secured in an airtight manner between the at least one housing and the at least one flow adapter. According to the invention, a discharge channel arrangement is constructed in the coupling frame.

In the ventilation device, the at least one flow adapter, the at least one housing with the at least one filter element and the at least one fan are connected consecutively in the flow direction, so that the air can flow through the at least one flow adapter to the inlet opening of the at least one housing and further through the at least one filter element. In this case, the air can be aspirated from outside by means of the fan and can be conveyed through the at least one flow adapter further into the housing with the filter element. The housing can advantageously be produced from plastic—for example rotomoulded. The flow adapter can advantageously be flow-optimized and the geometry of the flow adapter can be adapted to the respective use case. The filter element expediently has a clean and a raw side and is formed from a filter material. The filter material can in this case be hydrophobic for example, and separate the water found in the aspirated air in a filtering zone. The water separated in the filter element can then be deposited on the raw side of the filter element under the action of gravity into a drainage zone of the filter element. The drainage zone adjoins the filtering zone of the filter element and is expediently arranged offset transversely to the flow direction below the filtering zone of the filter element. The filtering zone of the filter element in this case corresponds with a filtering region and the drainage zone corresponds with a drip-off region of the housing. The filtering region and the drip-off region of the housing are adjacent to one another in this case.

In this case, the coupling frame connects the at least one housing to the at least one flow adapter in the flow direction in an air-conducting manner and in an airtight manner transversely to the flow direction. As a result, a pressure chamber of the ventilation device can be sealed and maintained in particular. The coupling frame can furthermore take on a supporting function and stabilize the ventilation device against deformation. The discharge channel arrangement is constructed in the coupling frame, so that the water separated in the at least one filter element can be conveyed out of the drip-off region of the respective housing via the coupling frame to the outside. In this case, the discharge channel arrangement can connect the drip-off regions of the plurality of housings in a fluidic manner. Advantageously, the mounting and the maintenance of the discharge channel arrangement constructed in the coupling frame is simplified considerably.

Advantageously, the discharge channel arrangement can have at least one horizontal gulley channel, which is connected in a fluidic manner to a drip-off region of at least one of the housings. In the operating state, the gulley channel is aligned with a deviation of up to 10° in relation to the ground, in order to be able to convey the water separated in the filter element horizontally in the ventilation device under the action of gravity. In this case, the individual gulley channel can connect the drip-off regions of the plurality of housings arranged next to one another to the corresponding filter elements in a fluidic manner. Advantageously, the discharge channel arrangement can have at least two gulley channels arranged above one another, which are connected to one another in a fluidic manner by at least one vertical discharge channel. In this case, the gulley channels arranged above one another connect the drip-off regions of the housings in one horizontal row in each case and the at least one vertical discharge channel connects the gulley channels to one another vertically in a fluidic manner. In the operating state, the vertical discharge channel is arranged vertically with a deviation of up to 10° in relation to the ground, so that the water separated in the filter element can be conveyed under the action of gravity out of an upper gulley channel with respect to the ground into the lower gulley channel with respect to the ground. Advantageously, in this manner a drainage of the water separated in the filter element can be ensured in the discharge channel arrangement at every operating point of the ventilation device without additional force action exclusively under the action of gravity. The water separated in the filter elements can subsequently be conveyed out of the discharge channel arrangement to the outside. Expediently, to this end, the lowermost gulley channel with respect to the ground can have a discharge opening at its lowest point. In this advantageous manner, the plurality of housings and the plurality of filter elements are connected in a fluidic manner to one another by means of the discharge channel arrangement in the coupling frame and the water separated in the plurality of filter elements can be drained from the ventilation device in a simplified manner. Preferably, the at least one gulley channel is formed from a u-shaped metallic profile and the at least one discharge channel is formed from a u-shaped or l-shaped metallic profile.

It is provided in an advantageous development of the ventilation device according to the invention, that the at least one flow adapter is in one piece and preferably made from plastic. The at least one flow adapter is consequently shaped robustly in such a manner that the air aspirated from outside by the at least one fan is already distributed in the flow adapter and can flow evenly via the filter element. In particular, the respective filter element can be protected and used longer as a result. Furthermore, the flow adapter made from plastic advantageously only slightly increases the empty weight of the ventilation system. In this case, the at least one flow adapter may have a collecting region and a flow region, which adjoin one another. The flow region of the flow adapter in this case corresponds in an air-conveying manner with the inlet opening of the housing and the collecting region is arranged offset transversely to the flow direction below the flow region. Furthermore, the collecting region lies outside a main air flow of the flow adapter. In the ventilation device, the flow region of the at least one flow adapter corresponds with the filtering region of the respective housing and the filtering zone of the respective filter element in the housing. By contrast, the collecting region is present offset transversely to the flow direction below the flow region of the flow adapter and no or an only negligibly small air flow is present in the collecting region.

Advantageously, it may be provided that the discharge channel arrangement connects the collecting region of the at least one flow adapter and a drip-off region of the at least one housing to one another in a fluidic manner. The water separated in the filter element can be guided through the discharge channel arrangement out of the respective housing into the collecting region of the at least one flow adapter counter to the flow direction. The collecting region of the flow adapter in this case lies outside of the air flow, so that no flow resistance counteracts the water separated in the filter element during the flow into the collecting region of the flow adapter. Expediently, to this end, the lowermost gulley channel of the discharge channel arrangement with respect to the ground can be connected in a fluidic manner at its deepest point by means of the discharge outlet to the collecting region of the at least one flow adapter—for example by means of a discharge line. To drain the water separated in the filter element out of the collecting region, the at least one flow adapter can have an adapter outlet opening leading outwards from the collecting region, which is connected in a fluid-conveying manner to the discharge channel arrangement. The water separated in the filter element can consequently be conveyed out of the respective housing via the discharge channel arrangement constructed in the coupling frame, into the collecting region of the flow adapter counter to the flow direction under the action of gravity without or with a low flow resistance. Inside the flow adapter, the water separated in the filter element can consequently be conveyed to the adapter outlet opening and further outwards counter to the flow direction under the action of gravity without or with a low flow resistance. In this advantageous manner, drainage of the water separated in the filter element can be ensured at each operating point of the ventilation device without additional force action. In particular, additional lines and pumps for draining the water separated in the filter element can as a result be dispensed with.

Advantageously, it is provided in a development of the ventilation device that the filter element, the housing and the fan in each case form a ventilation module with a flow surface. In this case, a plurality of identical ventilation modules are stacked on one another in a detachable manner to form the ventilation device, such that a total flow surface of the ventilation device corresponds to a multiple of the flow surface of the individual ventilation module. The ventilation device can advantageously be constructed in a modular manner as a result and depending on requirements, can be expanded using further ventilation modules. Furthermore, the individual identically designed ventilation modules can be exchanged with one another in a simplified manner so that the mounting and the maintenance of the ventilation device are simplified.

It can advantageously be provided that at least two neighbouring ventilation modules in the ventilation device in each case have a cable receptacle recess extending in the flow direction on the housings thereof. In this case, the respective cable receptacle recesses bear against one another at the housings of the neighbouring ventilation modules in the flow direction and form a cable opening. The cable receptacle recesses may be designed identically, so that a cross-sectional area of the cable opening corresponds to double the cross-sectional area of the individual cable receptacle recess. The cable lines can be guided through the cable opening in the flow direction between the respective ventilation modules, so that without additional space requirement, electrical constituents of the ventilation device upstream and downstream of the respective ventilation module in the flow direction can be connected to one another.

In order to be able to stack the individual ventilation modules on one another in a detachable manner, advantageously, one of the neighbouring ventilation modules in the ventilation device can have at least one recess extending in the flow direction on its housing, and another of the neighbouring ventilation modules in the ventilation device can have at least one moulding extending in the flow direction on its housing. The at least one recess and the at least one moulding are in engagement transversely to the flow direction in this case and form a so-called tongue and groove connection. The at least one recess and the at least one moulding in this way fix the neighbouring ventilation modules to one another in a detachable manner. In order to construct the respective ventilation modules identically, the at least one recess and the at least one moulding can be constructed on the respective housing in each case. Expediently, these are constructed on opposite housing sides, so that the ventilation modules stacked above one another or next to one another can be secured to one another in a detachable manner.

In a preferred embodiment of the ventilation device, it is provided that the ventilation device has four ventilation modules and a single flow adapter. In this case, the ventilation modules are secured to one another in a detachable manner to form a 2×2 stacked block and secured by means of a coupling frame on the flow adapter in an air-conveying manner. The respective ventilation modules are designed identically and in each case have a cuboid housing with a cuboid filter element and a fan. The flow adapter is secured on the respective ventilation module by means of the coupling frame.

Advantageously, the coupling frame can have a module support frame surrounding the respective ventilation modules transversely to the flow direction and an adapter support frame supporting the at least one flow adapter. The module support frame and the adapter support frame can be mounted such that they can be folded or displaced together by means of a hinge apparatus and can be secured to one another by means of a closure unit. In this advantageous embodiment of the ventilation device, the coupling frame can be opened and the filter element can for example be replaced in the respective ventilation module in a simplified manner. The discharge channel arrangement can then be constructed in the adapter support frame for example. A passage arrangement for the inlet opening of the respective housing can advantageously be secured on the coupling frame transversely to the flow direction. The passage arrangement—preferably a jalousie arrangement—is provided in this case for controlling the volumetric air flow through the respective ventilation module.

In a development of the ventilation device according to the invention, it is advantageously provided that the respective filter element has a peripheral sealing edge. In this case, the sealing edge bears on one side against a sealing surface of the housing surrounding the inlet opening and on the other side against the coupling frame and seals the respective housing around the inlet opening to the coupling frame, transversely to the flow direction. The sealing edge seals the pressure chamber of the ventilation device and is arranged on the filter element, so that during insertion or during replacement of the respective filter element in the ventilation device, the sealing edge can also be inserted or replaced. In particular, the sealing of the pressure chamber of the ventilation device can be undertaken by means of the sealing edge in a tool-free manner and as a result, the time and force outlay during the first and during renewed sealing of the ventilation device can be reduced. In this case, the sealing surface can be formed by a housing frame surrounding the inlet opening, which forms a radially inwardly protruding inlet stage in the respective housing. In this advantageous manner, the air flow can be conveyed to the filter element in the respective housing without losses. For sealing, an elastic seal can in this case be secured on a side surface of the sealing edge facing the housing and/or the coupling frame. In this case, the elastic seal can be secured in a materially connected manner—for example adhesively bonded—or else non-positive manner—for example latched into a profile groove—at the side surfaces of the sealing edge.

In an advantageous development of the ventilation device according to the invention, it is provided that the respective fan is controlled by a control device. The control device has at least one measuring arrangement for detecting the volumetric air flow through the respective filter element. The at least one measuring arrangement has a pressure measuring unit in this case, for detecting a static pressure, which is arranged inside the ventilation device. The static pressure in the respective filter element can be detected by means of the pressure measuring unit and the volumetric air flow through the respective filter element can be determined therefrom. In particular, a direct and imprecise measurement of the volumetric air flow in the respective filter housing and the ventilation device can be controlled more precisely.

Advantageously, the respective pressure measuring unit can be connected in a fluidic manner to a pressure measurement point or have a pressure measurement point of this type. In this case, the pressure measurement point is arranged inside the housing in the region of the inlet opening and has a measurement opening there. In this case, the measurement opening can penetrate the respective housing, so that the pressure measuring unit arranged outside the housing can detect the static pressure inside the housing and the filter element. The respective pressure measurement point or the measurement opening thereof can advantageously be arranged in a drip-off region of the housing. In this case, the drip-off region of the housing corresponds with a drainage zone of the filter element, which is provided for draining the water separated in the filter element. The drainage zone of the filter element is in this case connected to a filtering zone of the filter element and is arranged transversely to the flow direction below the filtering zone of the filter element. In order to protect the pressure measuring unit or the pressure measurement point thereof from water and dirt, the pressure measurement point can be arranged on a clean side of the filter element in the respective housing. Advantageously, the respective pressure measurement point or the measurement opening thereof can be integrated into the housing or secured in the same in a low-flow zone of the drip-off region of the housing. In this case, the low-flow zone of the drip-off region of the housing can correspond with a low-flow zone of the drainage zone of the filter element. In this context “low-flow” means that the air flow prevailing at the pressure measurement point or the measurement opening thereof is negligibly low for a measurement of the static pressure or causes a measurement error of below 5% in the measurement of the static pressure.

Advantageously, the housing can have a housing frame surrounding the inlet opening with a radially inwardly protruding inlet stage. In order to increase the measurement accuracy when detecting the static pressure in the respective housing, through which flow takes place, the pressure measurement point can be arranged at the inlet stage. The measurement opening can in this case be aligned open in the flow direction and substantially parallel—in this context with a deviation of up to 30°—to the flow direction. Expediently, the measurement opening is arranged in the respective housing in such a manner that no or only a negligibly small air flow prevails at the pressure measurement point or at the measurement opening. In particular, the measured static pressure can as a result be detected independently of the dynamic pressure prevailing in the respective housing.

In summary, the water separated in the respective filter element is drained to the outside in a simplified manner in the ventilation device according to the invention. Advantageous further embodiments of the ventilation device further make it possible to build the ventilation device in a modular manner; to simplify sealing of the ventilation device; to control the ventilation device more precisely and to distribute the air flow in the respective filter element better.

Further important features and advantages of the invention result from the dependent claims, from the drawings and from the associated description of the figures on the basis of the drawings.

It is understood that the previously mentioned features and the features which are still to be mentioned in the following, can be used not only in the respectively specified combination, but also in other combinations or alone, without departing from the scope of the present invention.

Preferred exemplary embodiments of the invention are illustrated in the drawings and are explained in more detail in the following description, wherein identical reference numbers refer to identical or similar or functionally identical components.

### BRIEF DESCRIPTION OF THE DRAWINGS

In the figures, in each case schematically

FIG. 1 shows a view of a ventilation device according to the invention;

FIG. 2 shows a view of the ventilation device shown in FIG. 1 from the front;

FIG. 3 shows a view of the ventilation device shown in FIG. 1 from the rear;

FIG. 4 shows a side view of the ventilation device shown in FIG. 1;

FIG. 5 shows a view of the ventilation device shown in FIG. 1 from above;

FIG. 6 shows a sectional view of the ventilation device shown in FIG. 1;

FIG. 7 shows a side view of a ventilation module of the ventilation device shown in FIG. 1;

FIG. 8 shows a view of the ventilation module of the ventilation device shown in FIG. 1 from above;

FIG. 9 shows a sectional view of the ventilation module of the ventilation device shown in FIG. 1;

FIG. 10 shows a view of a flow adapter of the ventilation device shown in FIG. 1;

FIG. 11 shows a partial sectional view of the flow adapter of the ventilation device shown in FIG. 1;

FIG. 12 shows a view of the flow adapter of the ventilation device shown in FIG. 1 from the rear;

FIG. 13 shows a view of the flow adapter of the ventilation device shown in FIG. 1 from above;

FIG. 14 shows a sectional view of the ventilation device shown in FIG. 1;

FIG. 15 shows a further sectional view of the ventilation device shown in FIG. 1.

### DETAILED DESCRIPTION

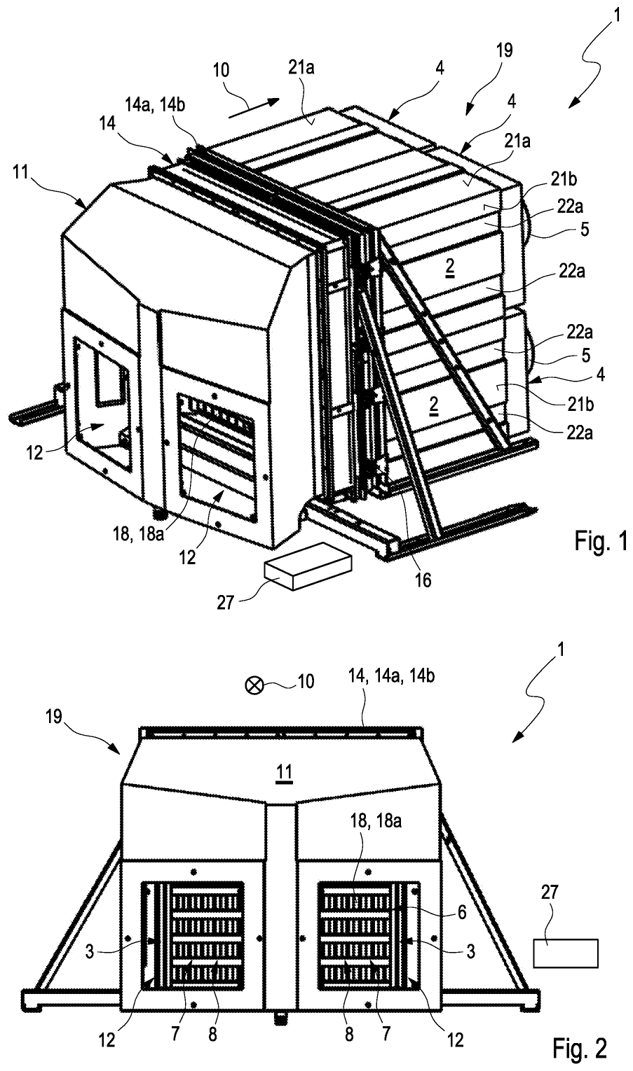

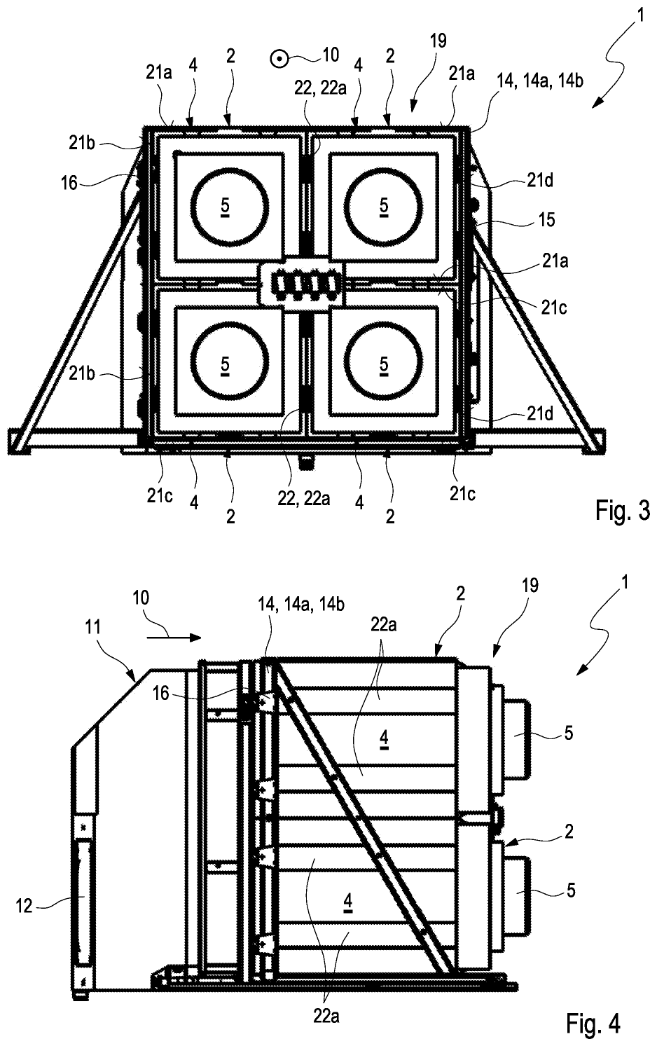

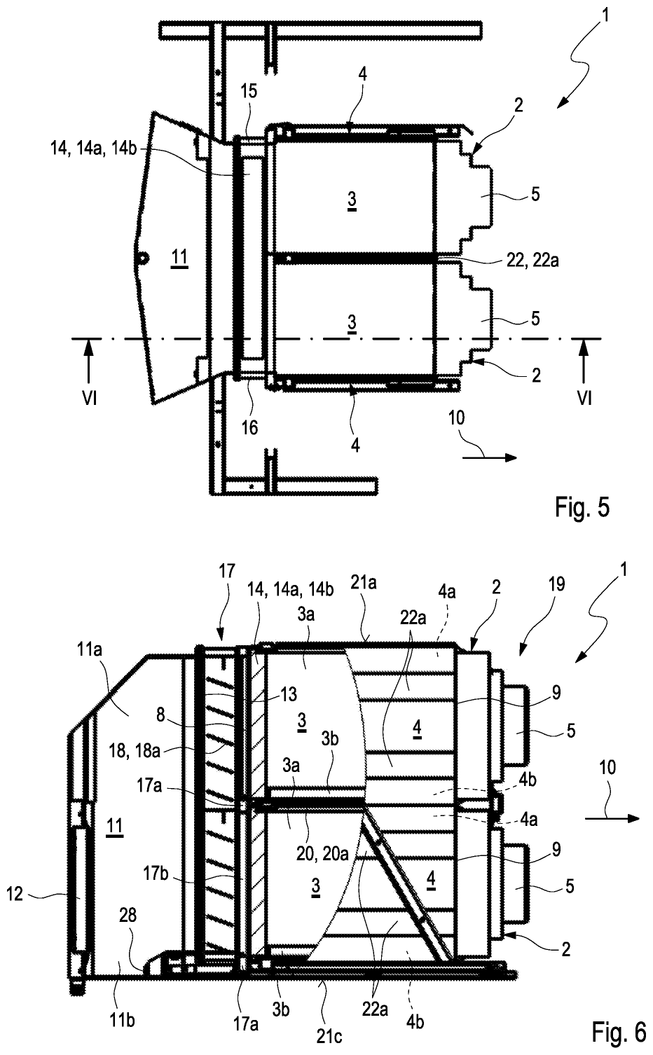

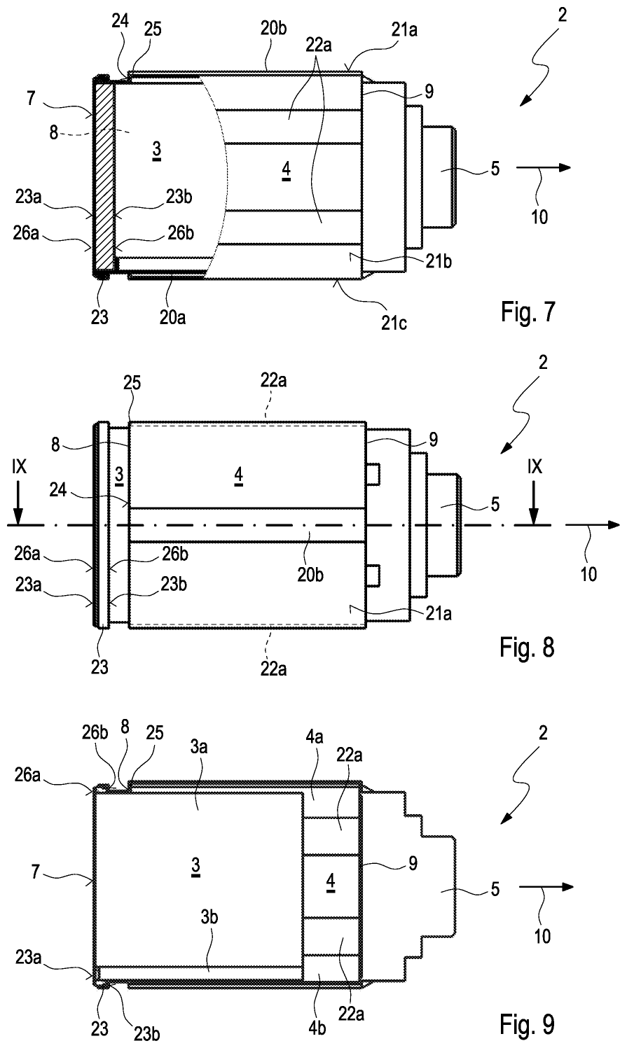

FIG. 1 shows a view of a ventilation device 1 according to the invention for filtering air and for separating water aerosols from air. The ventilation device 1 is shown in FIG. 2 from the front; in FIG. 3 from the rear; in FIG. 4 from the side; in FIG. 5 from above and in FIG. 6 in section. The terms “front” and “rear” here and in the following relate to the air flowing through the ventilation device 1, which air flows through the installed ventilation device 1 in the operating state from the “front” to the “rear” parallel or virtually parallel to the ground. The terms “above” and “below” relate accordingly to the alignment of the installed ventilation device 1 with respect to the ground. The ventilation device 1 has a total of four ventilation modules 2, wherein the respective ventilation module 2 has a filter element 3, a housing 4 and a fan 5. The ventilation modules 2 are identical and stacked on one another in a detachable manner to form a stacked block 19, so that a total flow surface 6 of the ventilation device 1 corresponds to a multiple of the flow surface 7 of the individual ventilation module 2. In the respective ventilation module 2, the filter element 3 is arranged in the respective housing 4 and air can flow from an inlet opening 8 to an outlet opening 9 of the housing 4 in a flow direction 10. The respective fan 5 is secured on the outlet opening 9 downstream of the respective housing 4 in the flow direction 10. The respective fan 5 is controlled by a control device 27, which has a measuring arrangement for detecting the volumetric air flow through the respective filter element 3. The structure of the ventilation module 2 is illustrated in detail in FIG. 7 to FIG. 9.

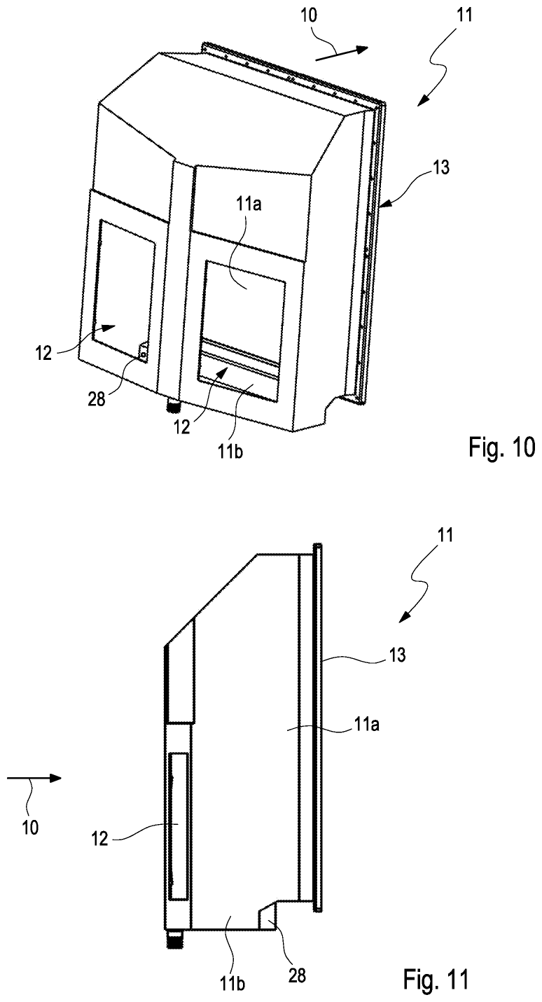

Furthermore, the ventilation device 1 has a flow adapter 11, which is secured on the respective inlet opening 8 upstream of the respective housing 4 in the flow direction 10. The flow adapter 11 in this case has two air inlets 12 and an air outlet 13, which corresponds in a fluidic manner with the respective inlet opening 8 of the respective housing 4. In this case, the flow adapter 11 is in one piece—for example made from plastic—and robust, so that the air already aspirated from outside by the respective fan 5 is already distributed in the flow adapter 11. The air aspirated from outside then flows evenly over the respective filter elements 3 and the latter are protected. In FIG. 10 to FIG. 13, the structure of the flow adapter 11 is shown in detail.

In the ventilation device 1, the flow adapter 11 and the respective housing 4 are subsequently connected consecutively in the flow direction 10 to the respective filter element 3 and the respective fan 5, so that the air the air can flow through the air inlets 12 of the flow adapter 11 via the air outlet 13 to the inlet opening 8 of the respective housing 4 and further through the respective filter element 3. In this case, the respective filter element 3—as shown in FIG. 6—has a clean and a raw side and is formed from a filter material. The filter material is hydrophobic and the water located in the aspirated air will separate in a filtering zone 3a on the raw side. The water separated in the filter element 3 is then deposited on the raw side of the filter element under the action of gravity into a drainage zone 3b of the filter element 3. The drainage zone 3b adjoins the filtering zone 3a of the filter element 3 and is arranged offset transversely to the flow direction 10 below the filtering zone 3a of the filter element 3.

The filtering zone 3a of the filter element 3 corresponds with a filtering region 4a and the drainage zone 3b corresponds with a drip-off region 4b of the housing 4. The filtering region 4a and the drip-off region 4b of the housing 4 are adjacent to one another in this case. Furthermore, the flow adapter 11 has a flow region 11a and a collecting region 11b, which adjoin one another. The flow region 11a of the flow adapter 11 in this case corresponds in a fluidic manner with the inlet openings 8 of the respective housing 4 and the collecting region 11b is arranged offset transversely to the flow direction 10 below the flow region 11a. Furthermore, the collecting region 11b lies outside a main air flow of the flow adapter 11.

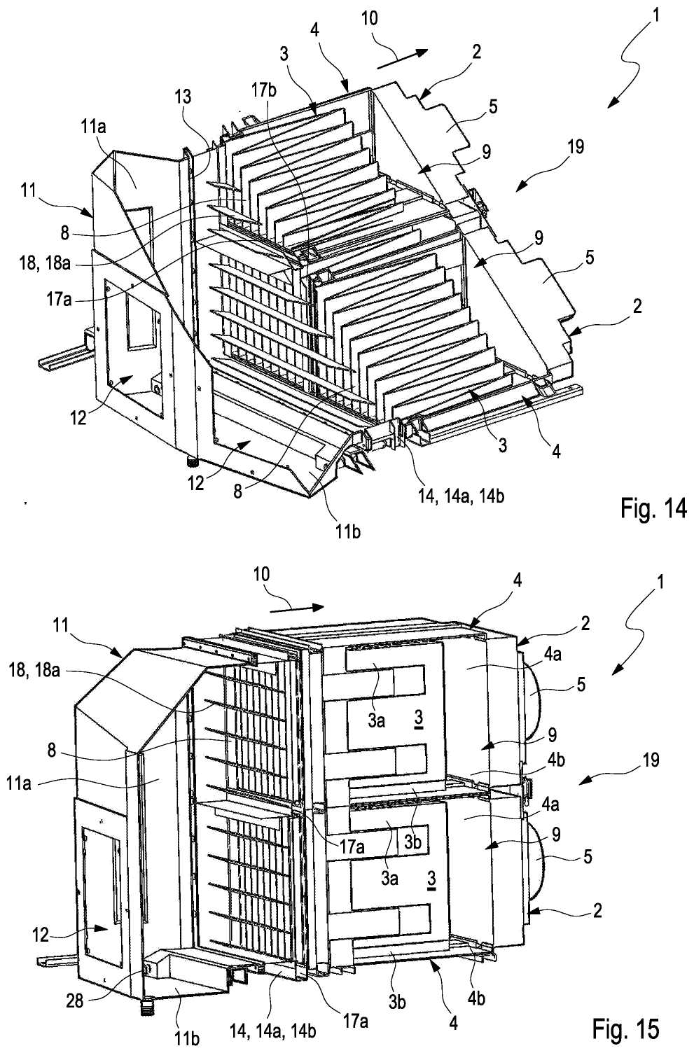

The ventilation modules 2 are secured in a detachable manner on the flow adapter 11 by means of a coupling frame 14. To this end, the coupling frame 14 has a module support frame 14a surrounding the respective ventilation modules 2 transversely to the flow direction 10 and an adapter support frame 14b supporting the flow adapter 11. The module support frame 14a and the adapter support frame 14b are mounted such that they can be folded together by means of a hinge apparatus 15 and can be secured to one another by means of a closure unit 16. Thus, the coupling frame 14 can be opened and the filter element 3 can for example be replaced in the respective ventilation module 2 in a simplified manner. A discharge channel arrangement 17 for draining the water separated in the respective filter element 3 is furthermore constructed in the coupling frame 14. The discharge channel arrangement 17—as shown in FIG. 6—in this case has two horizontal gulley channels 17a arranged above one another and a vertical discharge channel 17b. The respective gulley channel 17a in each case connects the drip-off regions 4b of the neighbouring housing 4 in series of the ventilation modules 2 to the discharge channel arrangement 17 and the discharge channel 17b connects the two gulley channels 17a to one another in a fluidic manner. By means of the discharge channel arrangement 17, the water separated in the respective filter element 3 can be guided outwards through the discharge channel arrangement 17 under the action of gravity. In FIG. 14 and FIG. 15, the structure of the discharge channel arrangement 17 is shown in detail. Furthermore, a passage arrangement 18—here a jalousie arrangement 18a—for the inlet opening 8 of the respective housing 4 is secured on the coupling frame 14 transversely to the flow direction 10. The passage arrangement 18 is provided for controlling the volumetric air flow through the respective ventilation module 2.

FIG. 7 shows a side view of an individual ventilation module 2 in the ventilation device 1. The ventilation module 2 is further shown in FIG. 8 from above and in section in FIG. 9. In order to stack the individual ventilation modules 2 on one another in a detachable manner to form the stacked block 19, the respective ventilation module 2 in the ventilation device 1 has a recess 20a extending in the flow direction 10 and a moulding 20b extending in the flow direction 10 on the housing 4 thereof. The recess 20a and the moulding 20b of the neighbouring ventilation modules 2 are in this case in engagement transversely to the flow direction 10 and form a so-called tongue and groove connection. The recess 20a and the moulding 20b fix the neighbouring ventilation modules 2 to one another in a detachable manner in this manner to form the stacked block 19. The recess 20a and the moulding 20b are constructed on the respective housing 4 on opposite housing sides 21a and 21c, as is also shown in FIG. 1 to FIG. 6 and in FIG. 14 to FIG. 15.

Furthermore, the respective ventilation module 2 has two cable receptacle recesses 22a extending in the flow direction 10 on the housing 4 thereof on the opposite housing sides 21b and 21d in each case. In the stacked block 19, the respective cable receptacle recesses 22a bear against one another at the housings 4 of the neighbouring ventilation modules 2 in the flow direction 10 and form a cable opening 22. The cable receptacle recesses 22a are designed identically, so that a cross-sectional area of the cable opening 22 corresponds to double the cross-sectional area of the individual cable receptacle recess 22a. The cable lines can be guided through the cable opening 22 in the flow direction 10 between the respective ventilation modules 2, so that without additional space requirement, electrical constituents of the ventilation device 1 upstream and downstream of the respective ventilation module 2 in the flow direction 10 can be connected to one another. The cable openings 22 out of the mutually adjacent cable receptacle recesses 22a are also shown in FIG. 1 to FIG. 6 and FIG. 14 to FIG. 15.

In order to fix the filter element 3 in the housing 4 transversely to the flow direction 10 in an airtight manner, the filter element 3 has a peripheral sealing edge 23 in the respective ventilation module 2. The sealing edge 23 in this case bears on one side against a sealing surface 24 of the housing 4 surrounding the inlet opening 8, and on the other side against the coupling frame 14. The sealing edge 23 is constructed on the filter element 3, so that during insertion or during replacement of the respective filter element 3 in the ventilation device 1, the sealing edge 23 is also inserted or replaced. The sealing surface 24 is in this case formed by a housing frame 25 surrounding the inlet opening 8. For sealing, an elastic seal 26a and 26b is secured—for example adhesively bonded—in each case on one of the side surfaces 23a and 23b of the sealing edge 23 facing the housing 4 and the coupling frame 14.

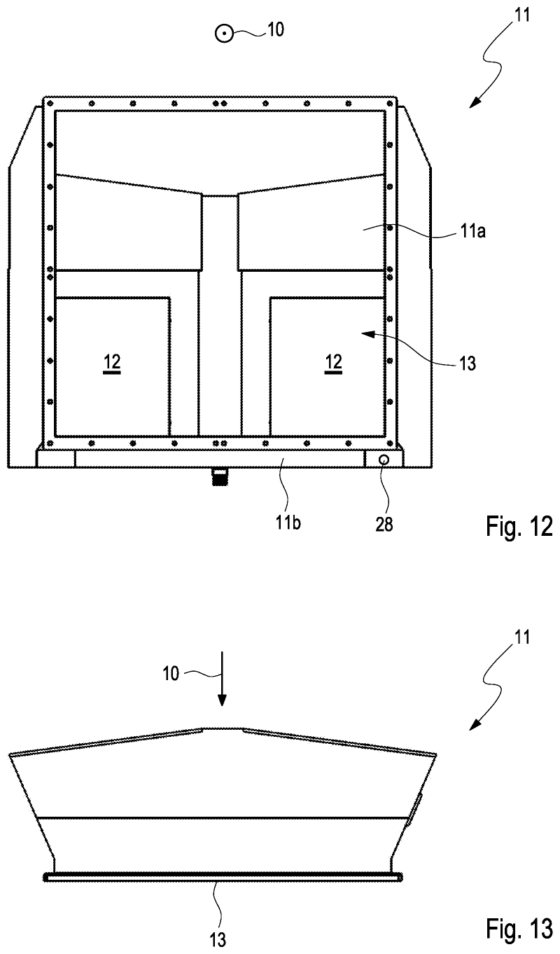

FIG. 10 shows a view of the flow adapter 11. Furthermore, the flow adapter 11 is shown partially in section in FIG. 11; from the rear in FIG. 12 and from above in FIG. 13. The flow adapter 11 has the air inlets 12 and the air outlet 13, which corresponds in a fluidic manner with the respective inlet opening 8 of the respective housing 4. The flow adapter 11 is formed in one piece and preferably from plastic. As a result, the flow adapter 11 is robust and the air aspirated from outside by the respective fan 5 is already distributed in the flow adapter 11 and flows evenly via the respective filter elements 3. The flow adapter 11 in this case has the flow region 11a and the collecting region 11b, which adjoin one another. The flow region 11a of the flow adapter 11 in this case corresponds in a fluidic manner with the inlet openings 8 of the respective housing 4 and the collecting region 11b is arranged offset transversely to the flow direction 10 below the flow region 11a. Furthermore, the collecting region 11b lies outside a main air flow in the flow adapter 11.

As already explained in FIG. 1 to FIG. 6, the discharge channel arrangement 17 is constructed in the coupling frame 14. This connects the collecting region 11b of the flow adapter 11 and the drip-off regions 4b of the respective housing 4 to one another in a fluidic manner. The water separated in the filter element 3 can be guided through the discharge channel arrangement 17 out of the respective housing 4 into the collecting region 17 of the flow adapter 11 counter to the flow direction 10. To this end, the collecting region 11b of the flow adapter 11 is connected in a fluidic manner to the discharge channel arrangement 17 via a discharge opening 28, wherein the discharge channel arrangement 17 is connected at its deepest point in the lower gulley channel 17a via a discharge line—not shown here—to the discharge opening 28. The water separated in the filter elements 3 is conveyed through the drainage opening 28 into the flow adapter 11 and guided outwards counter to the flow direction 10 in the collecting region 11b of the flow adapter 11. In FIG. 6, FIG. 14 and FIG. 15, the structure of the discharge channel arrangement 17 is shown in detail.

FIG. 14 and FIG. 15 show sectional views of the ventilation device 1. In the ventilation device 1, on one side, to form the stacked block 19, the individual ventilation modules 2, and on the other side, the flow adapter 11, are secured on the coupling frame 14. The discharge channel arrangement 17 is constructed in the coupling frame 14, which has two horizontal gulley channels 17a, arranged above one another, and a vertical discharge channel 17b. In the installed ventilation device, the respective gulley channel 17a is aligned horizontally with a deviation of up to 10° in relation to the ground, in order to be able to convey the water separated in the filter element 3 horizontally in the discharge channel arrangement 17 under the action of gravity. The respective gulley channel 17a in each case connects the drip-off regions 4b of the neighbouring housing 4, in series, of the ventilation modules 2 in the stacked block 19. The two gulley channels 17a are vertically connected in a fluidic manner via the discharge channel 17b. In the installed ventilation device 1, the vertical discharge channel 17b is arranged vertically with a deviation of up to 10° in relation to the ground, so that the water separated in the filter element 3 can be conveyed under the action of gravity out of the upper gulley channel 17a to the lower gulley channel 17a. The water separated in the filter elements 3 is subsequently conveyed out of the discharge channel arrangement 17 into the collecting region 11b of the flow adapter 11 and further outwards. To this end, the lower gulley channel 17a is connected in a fluidic manner at its deepest point by means of the discharge opening 28 to the collecting region 11b of the flow adapter. In this advantageous manner, the plurality of housings 4 and the plurality of filter elements 3 are connected in a fluidic manner to one another by means of the discharge channel arrangement 17 in the coupling frame 14 and the water separated in the plurality of filter elements 3 can be drained from the ventilation device 1 in a simplified manner.

In summary, the ventilation device 1 according to the invention can be built in a modular manner and the identically designed ventilation modules 2 can be exchanged with one another in a simple manner; furthermore, the water separated in the respective filter element 3 can be drained from the ventilation device 1 in a simplified manner; sealing of the ventilation device 1 can be controlled in a simplified manner and the ventilation device 1 can be controlled in a more precise manner, and the air flow in the respective filter element 3 can be distributed better.

1. A ventilation device for filtering air and for separating water aerosols from air, comprising:
at least one filter element, at least one housing, at least one fan, and at least one flow adapter;
the at least one filter element secured in the at least one housing such that air is flowable through an inlet opening of the at least one housing to an outlet opening of the at least one housing in a flow direction;
the at least one fan secured on the outlet opening downstream of the at least one housing in the flow direction;
the at least one flow adapter secured on the inlet opening upstream of the at least one housing in the flow direction;
a coupling frame secured in an airtight manner between the at least one housing and the at least one flow adapter; and
wherein the coupling frame includes a discharge channel arrangement for draining water collected in the at least one filter element.

2. The ventilation device according to claim 1, wherein the discharge channel arrangement includes at least one horizontal gulley channel connected in a fluidic manner to a drip-off region of the at least one housing.

3. The ventilation device according to claim 2, wherein:
the at least one gulley channel includes at least two gulley channels arranged one above the other; and
the discharge channel arrangement further includes at least one vertical discharge channel connecting the at least two gulley channels to one another in a fluidic manner.

4. The ventilation device according to claim 1, wherein the at least one flow adapter is structured as a single piece and composed of plastic.

5. The ventilation device according to claim 4, wherein:
the at least one flow adapter has a collecting region and a flow region;
the flow region corresponds with the inlet opening of the at least one housing in an air-conveying manner; and
the collecting region is arranged offset relative to the flow direction below the flow region and outside a main air flow of the at least one flow adapter.

6. The ventilation device according to claim 5, wherein:
the discharge channel arrangement connects the collecting region of the at least one flow adapter and a drip-off region of the at least one housing to one another in a fluidic manner; and
the drip-off region corresponds with a drainage zone of the at least one filter element for draining water separated in the at least one filter element.

7. The ventilation device according to claim 6, wherein:
the at least one flow adapter has an adapter outlet opening leading outwards from the collecting region; and
the adapter outlet opening is connected in a fluid-conveying manner to the discharge channel arrangement.

8. The ventilation device according to claim 1, further comprising a plurality of identical ventilation modules, wherein:
the at least one filter element includes a plurality of filter elements, the at least one housing includes a plurality of housings, and the at least one fan includes a plurality of fans;
each individual ventilation module of the plurality of ventilation modules has a flow surface and is defined by a filter element of the plurality of filter elements, a housing of the plurality of housings, and a fan of the plurality of fans; and
the plurality of ventilation modules are stacked on one another in a detachable manner such that a total flow surface of the ventilation device corresponds to a multiple of the flow surface of the individual ventilation module.

9. The ventilation device according to claim 8, wherein:
at least two neighbouring ventilation modules of the plurality of ventilation modules each have a cable receptacle recess of a plurality of cable receptacle recesses extending in the flow direction on the respective housing; and
the at least two neighbouring ventilation modules bear against one another such that the plurality of cable receptacle recesses are aligned in the flow direction and define a cable recess.

10. The ventilation device according to claim 9, wherein:
the housing of a first module of the at least two neighbouring ventilation modules has a recess extending in the flow direction;
the housing of a second module of the at least two neighbouring ventilation modules includes a moulding extending in the flow direction; and
the recess and the moulding are in engagement transversely to the flow direction and secure the at least two neighbouring ventilation modules to one another in a detachable manner.

11. The ventilation device according to claim 8, wherein:
the plurality of ventilation modules includes four ventilation modules;
the at least one flow adapter includes a single flow adapter; and
the four ventilation modules are secured to one another in a detachable manner to form a 2×2 stacked block and are secured on the single flow adapter in an air-conveying manner via the coupling frame.

12. The ventilation device according to claim 8, further comprising a hinge apparatus and a closure unit, wherein:
the coupling frame includes a module support frame surrounding the plurality of ventilation modules and an adapter support frame supporting the at least one flow adapter; and
the module support frame and the adapter support frame are movable together via the hinge apparatus and are securable to one another via the closure unit.

13. The ventilation device according to claim 12, wherein the discharge channel arrangement is arranged within the adapter support frame.

14. The ventilation device according to claim 8, further comprising a controllable passage arrangement for the inlet opening of a respective ventilation module of the plurality of ventilation modules, wherein the controllable passage arrangement extends perpendicular to the flow direction, is secured on the coupling frame, and is configured to control a volumetric air flow through the respective ventilation module.

15. The ventilation device according to claim 1, wherein the at least one filter element includes a peripheral sealing edge bearing on one side against a sealing surface of the at least one housing surrounding the inlet opening and, on another side, bearing against the coupling frame (H) and such that the peripheral sealing edge seals the at least one housing around the inlet opening to the coupling frame.

16. The ventilation device according to claim 15, wherein an elastic seal is secured on a side surface of the peripheral sealing edge facing at least one of the at least one housing and the coupling frame.

17. The ventilation device according to claim 1, further comprising a control device including at least one measuring arrangement structured and arranged to detect a volumetric air flow through the at least one filter element, wherein:
the at least one fan is controllable via the control device; and
the at least one measuring arrangement includes a pressure measuring unit structured and arranged to detect a static pressure.

18. The ventilation device according to claim 17, wherein:
the pressure measuring unit at least one of (i) includes and (ii) is connected in a fluidic manner to a pressure measurement point; and
the pressure measurement point is arranged inside the at least one housing in a region of the inlet opening and has a measurement opening.

19. The ventilation device according to claim 18, wherein:
at least one of the pressure measurement point and the measurement opening is arranged in a drip-off region of the at least one housing; and
the drip-off region corresponds to a drainage zone of the at least one filter element for draining water separated in the at least one filter element.

20. The ventilation device according to claim 18, wherein:
the at least one housing includes a housing frame surrounding the inlet opening and defining a radially inwardly protruding inlet stage;
the pressure measurement point is arranged at the inlet stage; and
the measurement opening is open in the flow direction and is aligned substantially parallel to the flow direction.
